(19) United States
(12) Patent Application Publication
(10) Pub. No.: US 2015/0139541 A1
(43) Pub. Date: May 21, 2015

(54) APPARATUS AND METHOD FOR DETECTING HARMFUL VIDEOS

(71) Applicant: ELECTRONICS AND TELECOMMUNICATIONS RESEARCH INSTITUTE, Daejeon-city (KR)

(72) Inventor: Su-Gil CHOI, Daejeon (KR)

(73) Assignee: ELECTRONICS AND TELECOMMUNICATIONS RESEARCH INSTITUTE, Daejeon-city (KR)

(21) Appl. No.: 14/506,163

(22) Filed: Oct. 3, 2014

(30) Foreign Application Priority Data
Nov. 19, 2013 (KR) 10-2013-0140879

(51) Int. Cl. G06T 7/40; G06K 9/00

(52) U.S. Cl. CPC G06T 7/408; G06K 9/00718; G06K 9/00744; G06T 2207/30196
USPC 382/165

(57) ABSTRACT

Disclosed herein is an apparatus and method for detecting harmful videos. The apparatus includes a video input unit for receiving an input video. A frame extraction unit extracts frames from the input video. A skin model generation unit generates a skin model for the frames extracted by the frame extraction unit. A color distribution-based determination unit determines whether the input video corresponds to a harmful video by comparing harmful color distribution information that is information related to a color distribution of preset harmful videos with target color distribution information. A skin area-based determination unit determines whether the input video corresponds to a harmful video by comparing a target skin area with harmful skin area information that is skin area information of preset harmful videos, the target skin area being extracted from the input video by separating an area corresponding to the skin model from the input video.

### CROSS REFERENCE TO RELATED APPLICATION

This application claims the benefit of Korean Patent Application No. 10-2013-0140879, filed Nov. 19, 2013, which is hereby incorporated by reference in its entirety into this application.

### BACKGROUND OF THE INVENTION

1. Technical Field

The present invention relates generally to an apparatus and method for detecting harmful videos and, more particularly, to an apparatus and method for detecting harmful videos, which generate skin color models specialized for respective videos on the presumption that a color appearing at high frequency in a video has a high probability of being skin, separate an area having a strong possibility of being a body using the generated skin color models, and determine whether each video is a harmful video, using the information of the separated area.

2. Description of the Related Art

With the development of communication network technology, and the popularization of PCs and mobile devices, downloading and viewing video content without temporal or spatial restrictions have recently become a part of the daily lives of people.

However, with the increase in the convenience of entertainment culture, the risk of impressionable growing children and adolescents being exposed to harmful content such as obscene (or pornographic) videos has also increased.

Accordingly, the demand for technology for analyzing video content, automatically determining whether the video content is harmful, and blocking harmful content has increased.

Technology for determining and blocking harmful content is implemented by comparing harmful words contained in a file name or file summary information with pre-registered information and then determining whether content is harmful. However, technology for determining and blocking harmful content using a file name or file summary information is problematic in that when a content spreader spreads the content after changing a file name or file summary information, it is difficult to block such content.

Further, most research into technology for detecting a skin color from an input video has been implemented by setting suitable boundary values in a color space using skin color information obtained from previously acquired videos, or by using a fixed skin color model based on a Gaussian distribution or a histogram.

However, such a method is problematic in that, when a skin color region is detected using a fixed skin color model, the region detected as a skin color region is smaller than an actual skin color region and an area other than a skin color region is erroneously detected, depending on the features of videos.

In detail, such problems arise because it is difficult to reflect all skin colors different for respective persons or races in skin color models, and the problem of skin color changing with the characteristics of lighting or cameras cannot be solved.

In order to solve these problems, methods of detecting a body part from a video and modeling a skin color from the detected region have been proposed. For example, after a face or an eye has been detected from a video, the color of the corresponding region around the face or the eye is regarded as being similar to that of other parts of the body, and a region corresponding to that color is detected as a skin color region. However, there are disadvantages in that the detection of a face region or an eye region may be inaccurate, and such methods cannot be applied to videos in which a face or an eye does not appear.

Therefore, there are required an apparatus and method for detecting harmful videos, which generate skin color models specialized for respective videos on the presumption that a color appearing at high frequency in a video has a high probability of being skin, separate a region having a strong possibility of being a body using the generated skin color models, and determine whether a current video is a harmful video, using the information of the separated region. Related technology is disclosed in Korean Patent Application Publication No. 10-2009-0041554.

### SUMMARY OF THE INVENTION

Accordingly, the present invention has been made keeping in mind the above problems occurring in the prior art, and an object of the present invention is to generate skin color models specialized for respective videos and precisely detect an obscene video using body area information detected via the skin color models.

Another object of the present invention is to more precisely detect a body area contained in a specific frame by filtering a background contained in a specific frame or objects other than a body part in consideration of pixel variations between specific frames upon generating skin color models.

A further object of the present invention is to enable a region having, to a preset degree, a color similar to that of an extracted skin area to be included so as to secure data required to generate skin color models.

In accordance with an aspect of the present invention to accomplish the above objects, there is provided an apparatus for detecting harmful videos, including a video input unit for receiving an input video, a frame extraction unit for extracting frames from the input video, a skin model generation unit for generating a skin model for the frames extracted by the frame extraction unit, a color distribution-based determination unit for determining whether the input video corresponds to a harmful video by comparing harmful color distribution information that is information related to a color distribution of preset harmful videos with target color distribution information that is a color distribution of the input video, and a skin area-based determination unit for determining whether the input video corresponds to a harmful video by comparing a target skin area with harmful skin area information that is skin area information of preset harmful videos, the target skin area being extracted from the input video by separating an area corresponding to the skin model from the input video.

The frame extraction unit may generate a frame set representing the input video by extracting a single frame for each preset frame interval and by combining individual extracted frames.

The frame extraction unit may include a successive frame module for extracting two or more successive neighboring frames, thus generating successive frames from the input video.

The skin model generation unit may include a single skin model module for extracting ranges of colors having frequencies equal to or greater than a preset frequency from the frame set, thus generating a skin model.

The skin model generation unit may include a successive skin model module for extracting ranges of colors having frequencies equal to or greater than a preset frequency from a changed pixel area only in a case where, based on a change in pixels between the respective frames constituting the successive frames, the pixel change is equal to or greater than a preset pixel change, thus generating a skin model.

The successive skin model module may be configured to, when the changed pixel area has a value less than or equal to a preset area, extract ranges of colors having frequencies equal to or greater than a preset frequency together with ranges of colors having preset similarity from the changed pixel area, thus generating a skin model.

The color distribution-based determination unit may include a color distribution frequency determination module configured to check a degree of distribution of colors included in the frames collected from the input video, based on the target color distribution information, and determine whether a specific color of the frames collected from the input video has a frequency equal to or greater than the preset frequency, compare the degree of the distribution of the colors with the harmful color distribution information, and determine that the input video corresponds to the harmful video if it is determined that the specific color has the frequency equal to or greater than the preset frequency.

The color distribution-based determination unit may include a color distribution similarity determination module for comparing the target color distribution information with a harmful color model for a color distribution, which is chiefly appearing on harmful videos and which is included in the harmful color distribution information, and then determining that the input video corresponds to the harmful video if the target color distribution information corresponds to the harmful color model.

The skin area-based determination unit may include a skin area generation module for, if it is primarily determined by the color distribution-based determination unit that the input video is a harmful video, separating and extracting the area corresponding to the skin model from the frames extracted from the input video, thus generating the target skin area.

The skin area-based determination unit may include a skin area analysis module for analyzing the target skin area and secondarily determining that the input video is a harmful video when the target skin area matches the harmful skin area information, wherein a case where the target skin area matches the harmful skin area information includes a case where a rate of the target skin area in the frames, a contour of the target skin area, and connection relationships between target skin areas respectively match those of the harmful skin area information.

In accordance with another aspect of the present invention to accomplish the above objects, there is provided a method for detecting harmful videos, including receiving, by a video input unit, an input video, extracting, by a frame extraction unit, frames from the input video, generating, by a skin model generation unit, a skin model for the extracted frames, primarily determining, by a color distribution-based determination unit, whether the input video corresponds to a harmful video by comparing harmful color distribution information that is information related to a color distribution of preset harmful videos with target color distribution information that is a color distribution of the input video, and secondarily determining, by a skin area-based determination unit, whether the input video corresponds to a harmful video by comparing a target skin area with harmful skin area information that is skin area information of preset harmful videos, the target skin area being extracted from the input video by separating an area corresponding to the skin model from the input video.

Extracting the frames may include generating, by a single frame module, a frame set representing the input video by extracting a single frame for each preset frame interval, and by combining individual extracted frames.

Extracting the frames may further include generating, by a successive frame module, extracting two or more successive neighboring frames and then generating successive frames from the input video.

Generating the skin model may include extracting, by a single skin model module, ranges of colors having frequencies equal to or greater than a preset frequency from the frame set, thus generating a skin model.

Generating the skin model may further include extracting, by a successive skin model module, ranges of colors having frequencies equal to or greater than a preset frequency from a changed pixel area only in a case where, based on a change in pixels between the respective frames constituting the successive frames, the pixel change is equal to or greater than a preset pixel change, thus generating a skin model.

The successive skin model module may be configured to, when the changed pixel area has a value less than or equal to a preset area, extract ranges of colors having frequencies equal to or greater than a preset frequency together with ranges of colors having preset similarity from the changed pixel area, and then generate a skin model.

Primarily determining whether the input video corresponds to the harmful video may include checking, by a color distribution frequency determination module, a degree of distribution of colors included in the frames collected from the input video, based on the target color distribution information, and determining whether a specific color of the frames collected from the input video has a frequency equal to or greater than the preset frequency, comparing the degree of the distribution of the colors with the harmful color distribution information, and determining that the input video corresponds to the harmful video if it is determined that the specific color has the frequency equal to or greater than the preset frequency.

Primarily determining whether the input video corresponds to the harmful video may include comparing, by a color distribution similarity determination module, the target color distribution information with a harmful color model for a color distribution, which is chiefly appearing on harmful videos and which is included in the harmful color distribution information, and then determining that the input video corresponds to the harmful video if the target color distribution information corresponds to the harmful color model.

Secondarily determining whether the input video corresponds to the harmful video may include if it is primarily determined that the input video is a harmful video, separating and extracting, by a skin area-based determination unit, the area corresponding to the skin model from the frames extracted from the input video, thus generating the target skin area.

Secondarily determining whether the input video corresponds to the harmful video may further include, after generating the target skin area analyzing, by a skin area analysis module, the target skin area and secondarily determining that the input video is a harmful video when the target skin area matches the harmful skin area information, wherein a case where the target skin area matches the harmful skin area information includes a case where a rate of the target skin area in the frames, a contour of the target skin area, and connection relationships between target skin areas respectively match those of the harmful skin area information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for detecting harmful videos according to the present invention;

FIG. 2 is a block diagram showing the frame extraction unit of the apparatus for detecting harmful videos according to the present invention;

FIG. 3 is a diagram showing the skin model generation unit of the apparatus for detecting harmful videos according to the present invention;

FIG. 4 is a diagram showing the color distribution-based determination unit of the apparatus for detecting harmful videos according to the present invention;

FIG. 5 is a diagram showing the skin area-based determination unit of the apparatus for detecting harmful videos according to the present invention;

FIG. 6 is a diagram showing the color distribution of harmless videos;

FIG. 7 is a diagram showing the color distribution of harmful videos; and

FIG. 8 is a flowchart showing a method of detecting harmful videos according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below.

The embodiments of the present invention are intended to fully describe the present invention to a person having ordinary knowledge in the art to which the present invention pertains. Accordingly, the shapes, sizes, etc. of components in the drawings may be exaggerated to make the description clearer.

Further, in the description of the components of the present invention, the terms such as first, second, A, B, (a), and (b) may be used. Such terms are merely intended to distinguish a specific component from other components and are not intended to limit the essential features, order, or sequential position of the corresponding component.

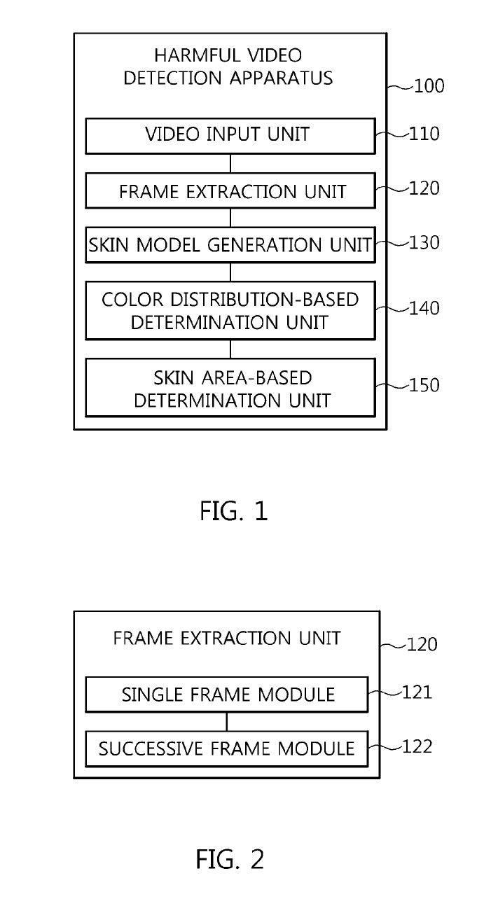

Hereinafter, an apparatus for detecting harmful videos according to the present invention will be described in detail with reference to the attached drawings. FIG. 1 is a block diagram showing an apparatus for detecting harmful videos according to the present invention.

Referring to FIG. 1, an apparatus 100 for detecting harmful videos (hereinafter referred to as a “harmful video detection apparatus”) according to the present invention includes a video input unit 110, a frame extraction unit 120, a skin model generation unit 130, a color distribution-based determination unit 140, and a skin area-based determination unit 150.

In detail, the video input unit 110 of the harmful video detection apparatus 100 according to the present invention receives an input video, and the frame extraction unit 120 extracts frames from the input video. The skin model generation unit 130 generates a skin model for the frames extracted by the frame extraction unit. The color distribution-based determination unit 140 determines whether the input video is a harmful video by comparing harmful color distribution information that is information related to the color distribution of preset harmful videos with target color distribution information that is the color distribution of the input video. The skin area-based determination unit 150 determines whether the input video is a harmful video by comparing a target skin area, extracted from the input video by separating an area corresponding to the skin model from the input video, with the harmful skin area information that is the skin area information of preset harmful videos.

The video input unit 110 functions to receive the input video.

In detail, the video input unit 110 functions to receive each video that is a target of detection of a harmful video.

The video may be stored in a storage medium and may be input using various methods such as a streaming service over the Internet.

Below, the frame extraction unit 120 will be described in detail.

FIG. 2 is a diagram showing the frame extraction unit of the harmful video detection apparatus according to the present invention. The frame extraction unit 120 functions to extract frames from the input video.

Referring to FIG. 2, the frame extraction unit 120 includes a single frame module 121 and a successive frame module 122.

In detail, the single frame module 121 functions to extract a single frame for each preset frame interval, combine extracted frames, and generate a frame set representing the input video.

More specifically, the video is composed of successive frames, each being a single still image.

Therefore, a frame is extracted per the preset number of frames, and then a frame set representing the video may be configured.

Further, since a problem may arise in that the quality of extracted frames decreases according to the compression scheme and the compressibility of videos, a scheme for extracting frames only when a preset quality condition is satisfied after a predetermined number of frames have passed, without necessarily extracting a frame per the preset number of frames may also be configured.

Furthermore, a scheme for detecting a section in which a change in content such as a change in scene is present and then extracting a representative frame from the section may also be configured.

The successive frame module 122 functions to extract two or more successive neighboring frames and generate successive frames from the input video.

More specifically, the successive frame module 122 configures a frame set representing the overall video by extracting a plurality of successive frames as well as extracting a single frame from each frame extraction section.

If only a single frame is extracted for each preset interval, information about a change between frames cannot be used, and thus a function of extracting a plurality of neighboring frames together with the single frame is required.

For an obscene video, since background changes are small, the frequency of a background color may be increased upon color frequency extraction.

Therefore, if a color having a high frequency in the video is modeled as a skin color, a problem may arise in that a background region is erroneously determined to be a body region.

Therefore, the precision of a skin model may be improved by extracting successive frames and limiting an analysis target to colors for which a change in pixel values between frames is a predetermined level or more.

Furthermore, upon calculating sections from which successive frames are to be extracted, the sections are preferably prevented from including sections in which a scene changes or a change in a video is large. This is a method for reducing a possibility that, as a change between pixel values in the background region has increased, the color of the background area will be reflected in the skin model. Details of the skin color model described in brief will be described later.

Below, the skin model generation unit 130 will be described.

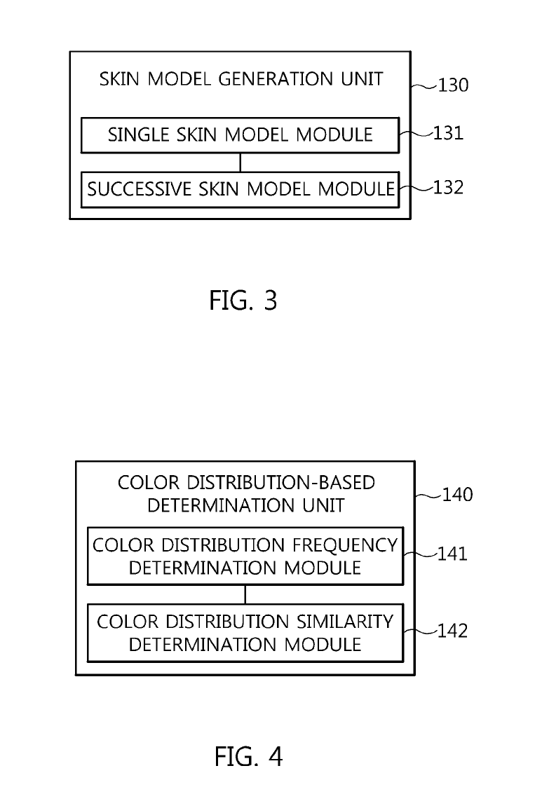

FIG. 3 is a diagram showing the skin model generation unit of the harmful video detection apparatus according to the present invention. The skin model generation unit 130 functions to generate a skin model for the frames extracted by the frame extraction unit.

Referring to FIG. 3, the skin model generation unit 130 includes a single skin model module 131 and a successive skin model module 132.

In detail, the single skin model module 131 functions to generate a skin model by extracting the ranges of colors having frequencies equal to or greater than a preset frequency from the frame set.

In greater detail, the single skin model module 131 applies the same weight to pixel values obtained from all collected frames and classifies colors having a strong probability of being a skin color.

Since, in an obscene video, there is a strong probability that colors of high frequency appearing in the overall video correspond to skin, the object of the invention is to identify such colors.

Methods of classifying colors of high frequency may include a plurality of methods, representatives of which may be a histogram-based method and a probability distribution estimation method.

In order to generate a histogram, the ranges of colors to be allocated to respective bins of the histogram must be determined, and the total number of bins may be calculated if the areas corresponding to the respective bins are determined

A histogram may be generated using a method of increasing the frequencies of bins, corresponding to the pixel values obtained from all of the collected frames, by 1, and the colors of regions corresponding to several high-ranking bins of high frequencies may be regarded as the skin color.

The histogram-based method is advantageous in that the calculation thereof is very simple and efficient, but has the problem of quantization in which colors located in the boundary portions of bins may be allocated to different bins even if they are similar to each other. In order to solve such a quantization problem, a probability distribution may be estimated and used.

Probability distribution estimation methods may be chiefly classified into a method based on nonparametric kernel estimation and a method based on parametric probability estimation.

The nonparametric method is characterized in that a computational load and the amount of memory used are large, but is advantageous in that a probability distribution may be more precisely obtained. In contrast, the parametric method is efficient for computation, but assumes that a probability distribution follows a specific shape, and thus there may be a large difference from an actual data distribution.

By using the above method, the ranges of colors of high frequency appearing in the video may be detected, and the relative importance levels of the respective color ranges may be obtained.

For example, in the histogram-based method, the relative frequency of the corresponding bin may be used as an indicator of importance level. The ranges of N high-ranking colors having higher importance levels may be used as skin colors, but, if the skin color contained in a video corresponds to the number of color ranges less than N, a color other than the skin color may be included. Therefore, the ranges of colors, the importance levels of which are equal to or greater than a threshold, may be used as the skin color.

The successive skin model module 132 functions to generate a skin model by extracting the ranges of colors having frequencies equal to or greater than a preset frequency from a changed pixel area, only in a case where, based on a change in pixels between the respective frames constituting the successive frames, the pixel change is equal to or greater than a preset pixel change.

In this case, the successive skin model module 132 is configured to, when the changed pixel area has a value less than or equal to a preset area, extract the ranges of colors of frequencies equal to or greater than a preset frequency, together with the ranges of colors having a preset similarity value from the changed pixel area, thus generating a skin model.

Specifically, the successive skin model module 132 analyzes several neighboring frames and classifies colors having a strong probability of being a skin color using only pixel values between which changes are equal to or greater than a threshold.

Basically, it is possible to collect pixel values, between which changes are equal to or greater than the threshold and model a skin color in the same manner as the single frame-based skin color generation module. However, in the case of an obscene video, the amount of data to be used for skin color modeling may be insufficient if pixel values are collected using such a method.

That is, unless the motion of a person is large in an obscene video in which the whole body of the person is exposed, there is a strong possibility that only a small number of pixel values will be selected using a method of selecting pixel values for which a difference between neighboring frames is equal to or greater than the threshold.

The reason for this is that a human body is composed of similar colors without having a specific pattern, and thus there is strong possibility that differences between pixel values will be small with the exception of boundary portions of the body even if there is a motion in the video.

Therefore, a method of selecting pixel values for which a difference between neighboring frames is equal to or greater than the threshold and then additionally exploiting pixel values similar to the selected pixel values may be used.

For example, if an area in which pixel values for which a difference between neighboring frames is equal to or greater than the threshold are selected is present only in the calf of a human body, a problem may arise in that the amount of data necessary for the generation of a skin model is insufficient.

Therefore, in this case, a skin model is generated to include, not only the color corresponding to the calf of the human body, but also colors having preset similarity to that of the calf. The reason for this is that the skin color of a normal person is not greatly different from each other depending on the parts of the body.

In this way, if a skin model is generated to include colors having similarity, the advantage of generating skin models using more various types of data may be obtained.

Below, the color distribution-based determination unit 140 will be described.

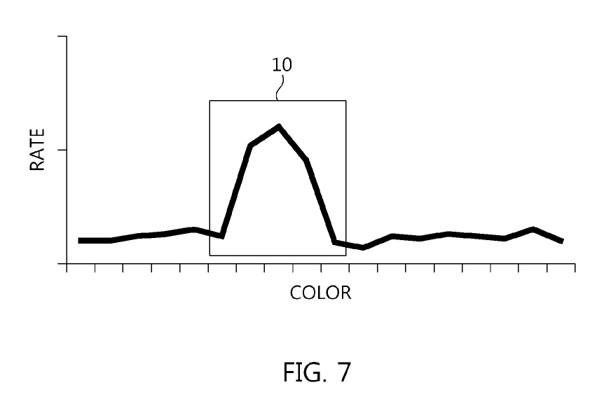

FIG. 4 is a diagram showing the color distribution-based determination unit of the harmful video detection apparatus according to the present invention. FIG. 6 is a diagram showing the color distribution of harmless videos. FIG. 7 is a diagram showing the color distribution of harmful videos.

The color distribution-based determination unit 140 functions to determine whether an input video corresponds to a harmful video by comparing harmful color distribution information which is information related to the color distribution of preset harmful videos with target color distribution information which is the color distribution of the input video.

Referring to FIG. 4, the color distribution-based determination unit 140 includes a color distribution frequency determination module 141 and a color distribution similarity determination module 142.

In detail, the color distribution frequency determination module 141 functions to check the distribution degree of colors included in frames collected from the input video based on the target color distribution information, compare the distribution degree with the harmful color distribution information, determine whether a specific color of frames collected from the input video has a frequency equal to or greater than a preset frequency, and then determine that the input video corresponds to the harmful video if the specific color has the frequency equal to or greater than the preset frequency.

Here, the term “target color distribution information” denotes information including the distribution information of colors included in the frames collected from the input video.

Further, the term “harmful color distribution information” denotes information including the distribution information of colors included in the frames of typical obscene videos.

In detail, referring to FIG. 6, the color distribution of typical videos can be depicted. That is, for the typical video, it can be seen that various colors are formed at a uniform rate.

In contrast, referring to FIG. 7, the color distribution of obscene videos can be depicted. In detail, it can be seen that a specific color 10 is formed at a high rate. Typically, the color formed at a high rate will be a skin color.

In this way, the color distribution frequency determination module 141 performs a function of analyzing the distribution degree of colors included in the frames collected from the input video, based on the degree of the harmful color distribution information.

That is, as the distribution degree of colors included in the frames collected from the input video is similar to that of the harmful color distribution, a probability that the input video corresponds to an obscene video is increased.

More specifically, the color distribution frequency determination module 141 performs a function of maximally exclude videos having strong possibility of not being obscene videos.

By maximally excluding typical videos before finally determining whether the input video corresponds to an obscene video, the present invention is advantageous in that processing having a relatively high computational load, such as the determination performed by the skin area-based determination unit 150, which will be described later, may be reduced, and in that a determination error by which typical videos are classified as obscene videos may be decreased.

Therefore, the color distribution frequency determination module 141 is intended to determine whether a color region occupying a high rate is present in the color distribution, rather than monitoring which color has appeared.

It is determined that there is a possibility that the input video will be an obscene video only when a color distribution is not uniform and a specific color region having a high rate is present. For detailed analysis, the input video is sent to the skin area-based determination unit 150.

In this way, the reason for not only determining whether the input video is an obscene video only using the color distribution frequency determination module 141, but also secondarily determining the input video using the skin area-based determination unit 150 is that the risk of falsely classifying the input video as an obscene video is present because, in a video in which a background represented by similar colors frequently appears as in the case of the sea or the mountain, the rate occupied by a specific color region is high.

The color distribution similarity determination module 142 functions to compare the target color distribution information with a harmful color model for a color distribution, which chiefly appears in harmful videos and which is included in the harmful color distribution information, and determine that the input video corresponds to a harmful video if the target color distribution information corresponds to the harmful color model.

In detail, the color distribution similarity determination module 142 functions to model a color distribution frequently appearing in obscene videos and determine the input video to be an obscene video if the color distribution obtained from the input video is similar to the color distribution of the obscene videos.

Even in the distribution of colors included in the frames extracted from obscene videos, colors in regions irrelevant to a skin color, such as that of a background, may be included. Therefore, although various color distributions may be generated due to variety in skin color, changes in the distribution of colors may occur due to colors included in the background or the like.

However, it may be assumed that the influence of the color of the background or the like on the color distribution is smaller than that of a skin color region on the color distribution. Further, it is important to decrease the influence of an area having a low probability and increase the influence of an area having a high probability, upon determining similarity between color distributions.

Below, the skin area-based determination unit 150 will be described.

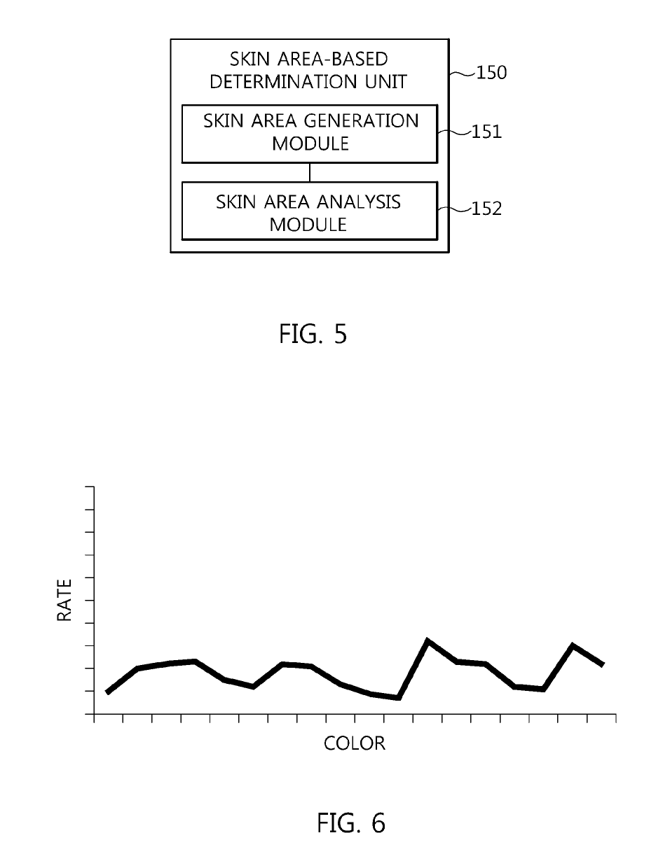

FIG. 5 is a diagram showing the skin area-based determination unit of the harmful video detection apparatus according to the present invention.

The skin area-based determination unit 150 functions to compare a target skin area, which is extracted from the input video by separating an area corresponding to the skin model from the input video, with harmful skin area information, which is skin area information of preset harmful videos, and then determine whether the input video corresponds to a harmful video.

Referring to FIG. 5, the skin area-based determination unit 150 includes a skin area generation module 151 and a skin area analysis module 152.

In detail, the skin area generation module 151 performs a function of, if it has been primarily determined by the color distribution-based determination unit 140 that the input video is a harmful video, separating and extracting an area corresponding to the skin model from frames extracted from the input video, thus generating a target skin area.

More specifically, the skin area generation module 151 functions to separate a skin area from the extracted frames, based on the skin model generated by the skin model generation unit 130. Such a skin area separation function is performed only when it is determined by the color distribution-based determination unit 140 that there is a possibility that an input video will be an obscene video, without being performed on all input videos.

If the skin model generated by the skin model generation unit 130 is very precise, it is possible to determine an area composed of only the corresponding colors to be a skin area. However, since the skin model may not be precise or complete, additional processing is required.

That is, the skin area information may be partially hidden by clothes or the like, but basically has continuous characteristics, and thus processing may be performed in such a way as to once separate an area corresponding to a skin model (skin color) generated by the skin model generation unit 130, regard a small region surrounded by skin areas as a skin area, and regard a region much smaller than other skin areas as a background area.

The skin area analysis module 152 functions to analyze the target skin area and secondarily determine that the input video is a harmful video if the target skin area matches the harmful skin area information.

In this case, the case where the target skin area matches the harmful skin area information means that the rate of the target skin area in the corresponding frame, the contour of the target skin area, and connection relationships between target skin areas respectively match those of the harmful skin area information.

In detail, by matching the target skin area, which is generated by the skin area generation module 151, with the harmful skin area information, which is information about areas including skin colors highly probably to have obscenity depending on the determination through learning, it is secondarily determined that the input video is a harmful video only in the case where the target skin area successfully matches the harmful skin area information.

Hereinafter, a method for detecting harmful videos according to the present invention will be described in detail. As described above, repeated descriptions of components identical to those of the harmful video detection apparatus 100 will be omitted.

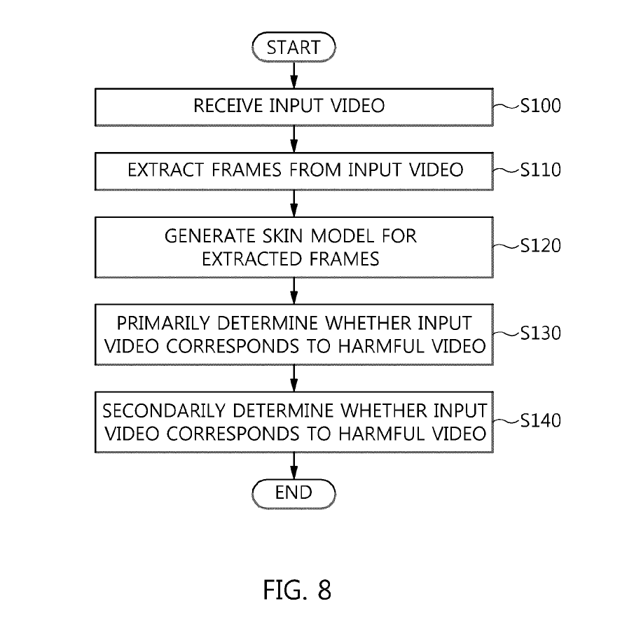

FIG. 8 is a flowchart showing a method for detecting harmful videos according to the present invention.

Referring to FIG. 8, the harmful video detection method according to the present invention includes steps S100 to S130. At step S100, by the video input unit, an input video is received. At step S110, by the frame extraction unit, frames are extracted from the input video. At step S120, by the skin model generation unit, a skin model for the frames extracted at the frame extraction step S110 is generated. At step S130, by the color distribution-based determination unit, it is primarily determined whether the input video corresponds to a harmful video by comparing harmful color distribution information, which is information related to the color distribution of preset harmful videos, with target color distribution information, which is the color distribution of the input video. At step S140, by the skin area-based determination unit, it is secondarily determined whether the input video corresponds to a harmful video by comparing a target skin area extracted from the input video by separating an area corresponding to the skin model from the input video with harmful skin area information which is skin area information of preset harmful videos.

As described above, in accordance with the harmful video detection apparatus and method according to the present invention, there are advantages in that skin color models specialized for respective videos can be generated and an obscene video can be precisely detected using body area information detected via the skin color models. Further, the present invention can more precisely detect a body area contained in a specific frame by filtering a background contained in a specific frame or objects other than a body part in consideration of pixel variations between specific frames upon generating skin color models.

Furthermore, the present invention enables a region having, to a preset degree, a color similar to that of an extracted skin area to be included so as to secure data required to generate skin color models.

As described above, in the harmful video detection apparatus and method according to the present invention, the configurations and schemes in the above-described embodiments are not limitedly applied, and some or all of the above embodiments can be selectively combined and configured so that various modifications are possible.

What is claimed is:

1. An apparatus for detecting harmful videos, comprising:
a video input unit for receiving an input video;
a frame extraction unit for extracting frames from the input video;
a skin model generation unit for generating a skin model for the frames extracted by the frame extraction unit;
a color distribution-based determination unit for determining whether the input video corresponds to a harmful video by comparing harmful color distribution information that is information related to a color distribution of preset harmful videos with target color distribution information that is a color distribution of the input video; and
a skin area-based determination unit for determining whether the input video corresponds to a harmful video by comparing a target skin area with harmful skin area information that is skin area information of preset harmful videos, the target skin area being extracted from the input video by separating an area corresponding to the skin model from the input video.

2. The apparatus of claim 1, wherein the frame extraction unit generates a frame set representing the input video by extracting a single frame for each preset frame interval and by combining individual extracted frames.

3. The apparatus of claim 2, wherein the frame extraction unit comprises a successive frame module for extracting two or more successive neighboring frames, thus generating successive frames from the input video.

4. The apparatus of claim 3, wherein the skin model generation unit comprises a single skin model module for extracting ranges of colors having frequencies equal to or greater than a preset frequency from the frame set, thus generating a skin model.

5. The apparatus of claim 4, wherein the skin model generation unit comprises a successive skin model module for extracting ranges of colors having frequencies equal to or greater than a preset frequency from a changed pixel area only in a case where, based on a change in pixels between the respective frames constituting the successive frames, the pixel change is equal to or greater than a preset pixel change, thus generating a skin model.

6. The apparatus of claim 5, wherein the successive skin model module is configured to, when the changed pixel area has a value less than or equal to a preset area, extract ranges of colors having frequencies equal to or greater than a preset frequency together with ranges of colors having preset similarity from the changed pixel area, thus generating a skin model.

7. The apparatus of claim 1, wherein the color distribution-based determination unit comprises a color distribution frequency determination module configured to:
check a degree of distribution of colors included in the frames collected from the input video, based on the target color distribution information, and
determine whether a specific color of the frames collected from the input video has a frequency equal to or greater than the preset frequency, compare the degree of the distribution of the colors with the harmful color distribution information, and determine that the input video corresponds to the harmful video if it is determined that the specific color has the frequency equal to or greater than the preset frequency.

8. The apparatus of claim 2, wherein the color distribution-based determination unit comprises a color distribution similarity determination module for comparing the target color distribution information with a harmful color model for a color distribution, which is chiefly appearing on harmful videos and which is included in the harmful color distribution information, and then determining that the input video corresponds to the harmful video if the target color distribution information corresponds to the harmful color model.

9. The apparatus of claim 1, wherein the skin area-based determination unit comprises a skin area generation module for, if it is primarily determined by the color distribution-based determination unit that the input video is a harmful video, separating and extracting the area corresponding to the skin model from the frames extracted from the input video, thus generating the target skin area.

10. The apparatus of claim 9, wherein the skin area-based determination unit comprises a skin area analysis module for analyzing the target skin area and secondarily determining that the input video is a harmful video when the target skin area matches the harmful skin area information,
wherein a case where the target skin area matches the harmful skin area information includes a case where a rate of the target skin area in the frames, a contour of the target skin area, and connection relationships between target skin areas respectively match those of the harmful skin area information.

11. A method for detecting harmful videos, comprising:
receiving, by a video input unit, an input video;
extracting, by a frame extraction unit, frames from the input video;
generating, by a skin model generation unit, a skin model for the extracted frames;
primarily determining, by a color distribution-based determination unit, whether the input video corresponds to a harmful video by comparing harmful color distribution information that is information related to a color distribution of preset harmful videos with target color distribution information that is a color distribution of the input video; and
secondarily determining, by a skin area-based determination unit, whether the input video corresponds to a harmful video by comparing a target skin area with harmful skin area information that is skin area information of preset harmful videos, the target skin area being extracted from the input video by separating an area corresponding to the skin model from the input video.

12. The method of claim 11, wherein extracting the frames comprises generating, by a single frame module, a frame set representing the input video by extracting a single frame for each preset frame interval, and by combining individual extracted frames.

13. The method of claim 12, wherein extracting the frames further comprises generating, by a successive frame module, extracting two or more successive neighboring frames and then generating successive frames from the input video.

14. The method of claim 13, wherein generating the skin model comprises extracting, by a single skin model module, ranges of colors having frequencies equal to or greater than a preset frequency from the frame set, thus generating a skin model.

15. The method of claim 14, wherein generating the skin model further comprises extracting, by a successive skin model module, ranges of colors having frequencies equal to or greater than a preset frequency from a changed pixel area only in a case where, based on a change in pixels between the respective frames constituting the successive frames, the pixel change is equal to or greater than a preset pixel change, thus generating a skin model.

16. The method of claim 15, wherein the successive skin model module is configured to, when the changed pixel area has a value less than or equal to a preset area, extract ranges of colors having frequencies equal to or greater than a preset frequency together with ranges of colors having preset similarity from the changed pixel area, and then generate a skin model.

17. The method of claim 11, wherein primarily determining whether the input video corresponds to the harmful video comprises:
checking, by a color distribution frequency determination module, a degree of distribution of colors included in the frames collected from the input video, based on the target color distribution information; and
determining whether a specific color of the frames collected from the input video has a frequency equal to or greater than the preset frequency, comparing the degree of the distribution of the colors with the harmful color distribution information, and determining that the input video corresponds to the harmful video if it is determined that the specific color has the frequency equal to or greater than the preset frequency.

18. The method of claim 12, wherein primarily determining whether the input video corresponds to the harmful video comprises:
comparing, by a color distribution similarity determination module, the target color distribution information with a harmful color model for a color distribution, which is chiefly appearing on harmful videos and which is included in the harmful color distribution information, and then determining that the input video corresponds to the harmful video if the target color distribution information corresponds to the harmful color model.

19. The method of claim 11, wherein secondarily determining whether the input video corresponds to the harmful video comprises:
if it is primarily determined that the input video is a harmful video, separating and extracting, by a skin area-based determination unit, the area corresponding to the skin model from the frames extracted from the input video, thus generating the target skin area.

20. The method of claim 19, wherein secondarily determining whether the input video corresponds to the harmful video further comprises, after generating the target skin area:
analyzing, by a skin area analysis module, the target skin area and secondarily determining that the input video is a harmful video when the target skin area matches the harmful skin area information,
wherein a case where the target skin area matches the harmful skin area information includes a case where a rate of the target skin area in the frames, a contour of the target skin area, and connection relationships between target skin areas respectively match those of the harmful skin area information.
